(19) United States
(12) Patent Application Publication
(10) Pub. No.: US 2023/0379097 A1
(43) Pub. Date: Nov. 23, 2023

(54) METHOD PERFORMED BY USER TERMINAL OR BASE STATION, USER TERMINAL AND BASE STATION

(71) Applicant: Samsung Electronics Co., Ltd., Suwon-si, Gyeonggi-do (KR)

(72) Inventors: Min WU, Beijing (CN); Feifei SUN, Beijing (CN); Qi XIONG, Beijing (CN)

(21) Appl. No.: 18/031,493

(22) PCT Filed: Oct. 8, 2021
(86) PCT No.: PCT/KR2021/013879

§ 371 Date: Apr. 12, 2023

(30) Foreign Application Priority Data
Oct. 13, 2020 (CN) 202011092362.X

(51) Int. Cl. H04L 1/1829; H04W 72/232

(52) U.S. Cl. CPC H04L 1/1854; H04W 72/232

(57) ABSTRACT

The present disclosure provides a method performed by a user terminal UE, a method performed by a base station, a user terminal and a base station. The method performed by a user terminal UE comprises: receiving information related to whether a hybrid automatic repeat request HARQ feedback function is disabled or not; based on the information, receiving downlink control information and a shared channel scheduled by the downlink control information.

### TECHNICAL FIELD

The present disclosure relates to the technical field of wireless communication, in particular to a method performed by a user terminal UE, a method performed by a base station, a user terminal and a base station.

### BACKGROUND ART

To meet the demand due to ever-increasing wireless data traffic after the commercialization of the 4th generation (4G) communication system, there have been efforts to develop an advanced 5th generation (5G) system or pre-5G communication system. For this reason, the 5G or pre-5G communication system is also called a beyond 4th-generation (4G) network communication system or post long term evolution (LTE) system. Implementation of the 5G communication system using ultra-frequency millimeter wave (mmWave) bands, e.g., 60 giga hertz (GHz) bands, is considered to attain higher data transfer rates. To reduce propagation loss of radio waves and increase a transmission range in the ultra-frequency bands, beamforming, massive multiple-input multiple-output (MIMO), Full Dimensional MIMO (FD-MIMO), array antenna, analog beamforming, and large-scale antenna techniques are under discussion. To improve system networks, technologies for advanced small cells, cloud Radio Access Networks (RANs), ultra-dense networks, device to device (D2D) communication, wireless backhaul, moving networks, cooperative communication, Coordinated Multi-Points (CoMP), reception-end interference cancellation and the like are also being developed in the 5G communication system. In addition, in the 5G system, an advanced coding modulation (ACM), e.g., hybrid frequency-shift keying (FSK) and quadrature amplitude modulation (QAM) (FQAM), sliding window superposition coding (SWSC), and an advanced access technology, e.g., filter bank multi carrier (FBMC), non-orthogonal multiple access (NOMA), and sparse code multiple access (SCMA), are being developed.

In the meantime, the Internet is evolving from a human-centered connectivity network where humans generate and consume information into an Internet of Things (IoT) network where distributed entities such as things transmit, receive and process information without human intervention. Internet of Everything (IoE) technologies combined with IoT, such as big data processing technologies through connection with a cloud server, for example, have also emerged. To implement IoT, various technologies, such as a sensing technology, a wired/wireless communication and network infrastructure, a service interfacing technology, and a security technology are required, and recently, even technologies for sensor network, Machine to Machine (M2M), Machine Type Communication (MTC) for connection between things are being studied. Such an IoT environment may provide intelligent Internet Technology (IT) services that generate a new value to human life by collecting and analyzing data generated among connected things. IoT may be applied to a variety of areas, such as smart homes, smart buildings, smart cities, smart cars or connected cars, smart grids, health care, smart home appliances and advanced medical services through convergence and combination between existing Information Technologies (IT) and various industrial applications.

In this regard, various attempts to apply the 5G communication system to the IoT network are being made. For example, technologies regarding a sensor network, M2M, MTC, etc., are implemented by the 5G communication technologies, such as beamforming, MIMO, array antenna schemes, etc. Even application of a cloud Radio Access Network (cloud RAN) as the aforementioned big data processing technology may be viewed as an example of convergence of 5G and IoT technologies.

As described above, various services can be provided according to the development of a wireless communication system, and thus a method for easily providing such services is required.

### DISCLOSURE OF INVENTION

### Technical Problem

There is a need for a method performed by a user terminal UE, a method performed by a base station, a user terminal and a base station.

### Solution to Problem

According to an aspect of the present disclosure, there is provided a method performed by a user terminal UE, the method comprises: receiving information related to whether a hybrid automatic repeat request, HARQ, feedback function is disabled or not; and based on the information, receiving downlink control information and a shared channel scheduled by the downlink control information.

According to an aspect of the present disclosure, there is provided a method performed by a base station, the method comprises: transmitting information related to whether a hybrid automatic repeat request HARQ feedback function is disabled or not; and transmitting downlink control information and a shared channel scheduled by the downlink control information.

According to another aspect of the present disclosure, there is provided a terminal, the terminal comprising: a transceiver configured to transmit and receive signals with the outside; and a processor configured to control the transceiver to perform a method according to any one of the above methods performed by the user terminal.

According to another aspect of the present disclosure, there is provided a base station comprising: a transceiver configured to transmit and receive signals with the outside; and a processor configured to control the transceiver to perform a method according to any one of the methods performed by the above base station.

According to another aspect of the present disclosure, there is provided a non-transitory computer-readable recording medium having stored thereon a program, which when performed by a computer, performs any one of the methods described above.

### Advantageous Effects of Invention

The present disclosure provides a method performed by a user terminal UE, a method performed by a base station, a user terminal and a base station. The user terminal UE receives information related to whether a hybrid automatic repeat request HARQ feedback function is disabled or not, and receives downlink control information and a shared channel scheduled by the downlink control information based on the information, thereby improving the reliability of data transmission.

### BRIEF DESCRIPTION OF DRAWINGS

FIG. 1 illustrates an exemplary wireless network according to various embodiments of the present disclosure;

FIG. 2a illustrates an example wireless transmission path according to an embodiment of the present disclosure;

FIG. 2b illustrates an example wireless reception path according to an embodiment of the present disclosure;

FIG. 3a illustrates an exemplary user equipment UE according to an embodiment of the present disclosure;

FIG. 3b illustrates an example base station gNB 102 according an embodiment of to the present disclosure;

FIG. 4 illustrates a flowchart of a method performed by a user equipment UE according to an embodiment of the present disclosure;

FIG. 5 illustrates a part of flowchart of a method performed by a user equipment UE according to an embodiment of the present disclosure;

FIG. 6 illustrates a schematic diagram of the joint use of blind retransmissions of PDSCH and PDSCH retransmissions based on HARQ feedback;

FIG. 7 illustrates a part of flowchart of a method performed by a user equipment UE according to an embodiment of the present disclosure;

FIG. 8 illustrates a part of flowchart of a method performed by a user equipment UE according to an embodiment of the present disclosure;

FIG. 9 illustrates a schematic diagram of cross distribution of aggregation slots of three UEs in time according to an embodiment of the present disclosure;

FIG. 10 illustrates a schematic diagram of an interval between each slot among a plurality of slots for PDSCH slot aggregation transmission according to an embodiment of the present disclosure;

FIG. 11 illustrates a schematic diagram of an interval between each slot bundle among a plurality of slots for PDSCH slot aggregation transmission according to an embodiment of the present disclosure;

FIG. 12 illustrates a flowchart of a method performed by a base station according to an embodiment of the present disclosure;

FIG. 13 is a block diagram showing the structure of an user terminal according to an embodiment of the present disclosure;

FIG. 14 is a block diagram showing the structure of a base station according to an embodiment of the present disclosure.

FIG. 15 is a block diagram illustrating a structure of a user equipment according to an embodiment of the present disclosure; and

FIG. 16 is a block diagram illustrating a structure of a base station according to an embodiment of the present disclosure.

### MODE FOR THE INVENTION

Other technical features may be readily apparent to one skilled in the art from the following figures, descriptions, and claims.

Before undertaking the DETAILED DESCRIPTION below, it can be advantageous to set forth definitions of certain words and phrases used throughout this disclosure. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this disclosure. Those of ordinary skill in the art should understand that in many, if not most, instances, such definitions apply to prior as well as future uses of such defined words and phrases. Embodiments of the present disclosure can be applied to Non-terrestrial networks (NTN), including but not limited to, for example, NTNs with 5G NR (New Radio) as radio access technology, NTNs with LTE (Long Term Evolution) as radio access technology, NTNs with LTE eMTC (LTE enhanced MTO, Internet of Things technology evolved based on LTE) as radio access technology, and NTNs with LTE NB-IOT (Narrow Band Internet of Things) as radio access technology, etc. With the wide-area coverage capability of satellites, NTN can enable operators to provide 5G commercial services in areas with poor ground network infrastructure and realize 5G service continuity, especially in emergency communication, maritime communication, aviation communication and communication along railways.

In addition, the embodiments of the present disclosure can also be applied to terrestrial communication networks, including but not limited to, for example, terrestrial communication networks with 5G NR as radio access technology, terrestrial communication networks with LTE as radio access technology, terrestrial communication networks with LTE eMTC as radio access technology, and terrestrial communication networks with LTE NB-IOT as radio access technology, etc.

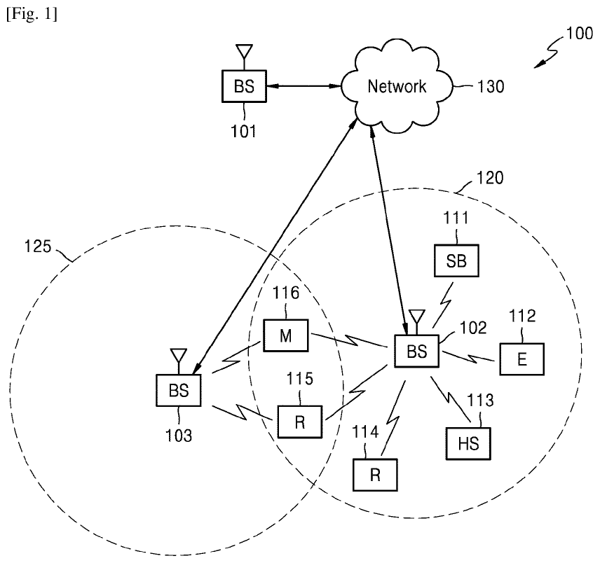

The following taking FIGS. 1 to 3b as examples to describe a terrestrial communication network to which embodiments of the present disclosure can be applied.

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station”,“BS ” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “user terminal”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

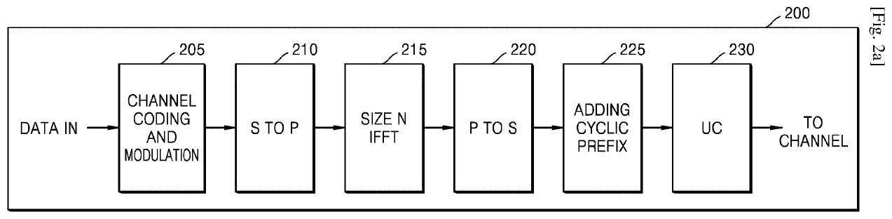

FIGS. 2a and 2b illustrate example wireless transmission and reception paths according to an embodiment of the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

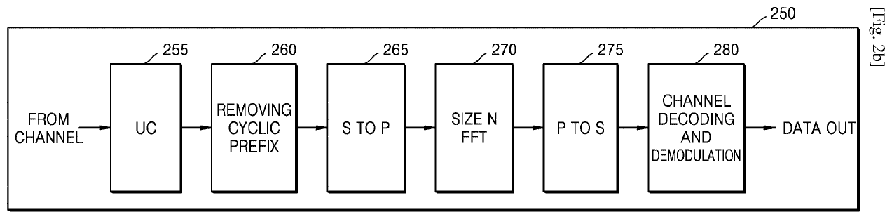

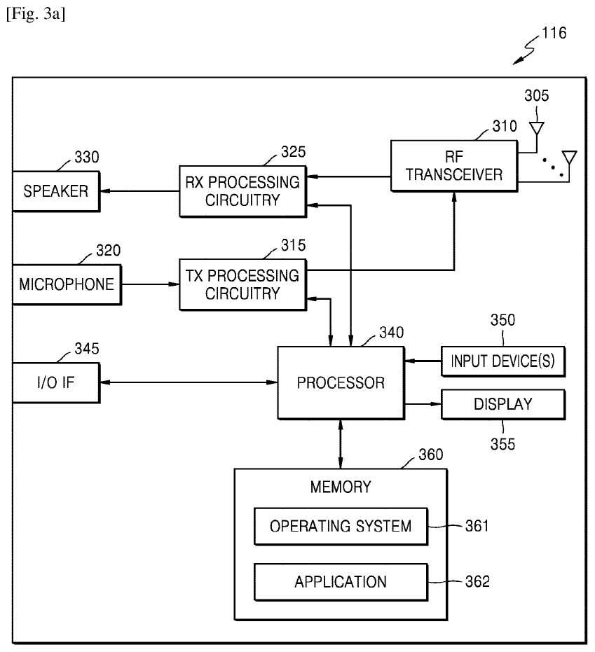

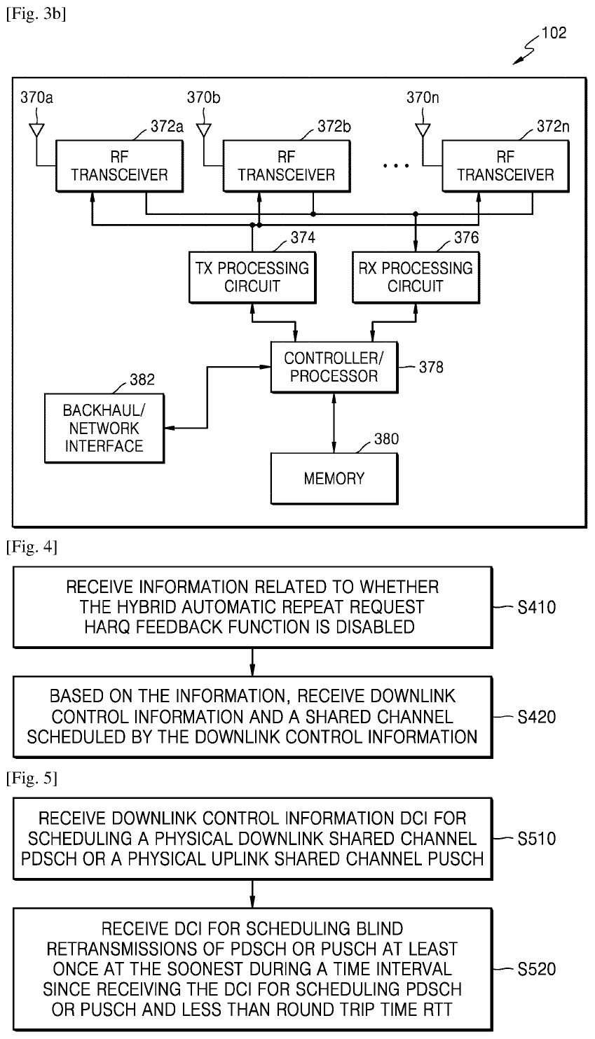

FIG. 3a illustrates an example UE 116 according to an embodiment of the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to an embodiment of the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD(Frequency Division Duplex) cells and TDD(Time Division Duplex) cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

In addition, various embodiments of the present disclosure can also be applied to non-terrestrial networks NTN. In NTN, according to whether satellites have the ability to decode 5G signals, it can be divided into two scenarios: a scenario based on transparent payload; and a scenario based on regenerative payload. In a scenario based on transparent payload, a satellite does not have the ability to decode 5G signals, and the satellite directly transmits the received 5G signals transmitted by a ground terminal to a NTN gateway on the ground. In a scenario based on regenerative payload, a satellite has the ability to decode 5G signals. The satellite decodes the received 5G signals transmitted by a ground terminal, and then re-encodes and transmits the decoded data, which can be directly transmitted to a ground NTN gateway, or transmitted to other satellites, and then transferred from other satellites to the ground NTN gateway.

In order not to obscure the inventive concept of the present disclosure, a detailed description of the implementation details of the non-terrestrial network NTN is omitted here. In an embodiment of the present disclosure, a base station may be a satellite or an aerial platform with decoding capability of a base station (i.e., a scenario based on transparent payload) and the like, or a satellite or an aerial platform without decoding capability of base station (i.e., a scenario based on regenerative payload) and the like. For the convenience of description, the satellites or aerial platforms and the like in NTN with or without decoding ability of base station are collectively described as base stations.

Exemplary embodiments of the present disclosure are further described below with reference to the accompanying drawings.

The text and drawings are provided as examples only to help the readers understand the present disclosure. They do not intend to limit and should not be interpreted as limiting the scope of this disclosure in any way. Although certain embodiments and examples have been provided, based on the disclosure herein, it will be apparent to those skilled in the art that changes may be made to the illustrated embodiments and examples without departing from the scope of the disclosure.

The following takes NTN network as an example for illustration, but it can be understood that this disclosure is not limited to NTN network.

Since the satellite is very high from the ground, for example, the altitude of the low-orbit satellite is 600 km or 1200 km, and the altitude of the synchronous satellite is close to 36000 km, the transmission delay of the communication signal between the ground terminal and the satellite is extremely large, even reaching tens or hundreds of milliseconds, which makes NTN need to use different physical layer technologies from those of the terrestrial network, which has an impact on technologies such as time and frequency synchronization/tracking, timing Advance of uplink transmission, physical layer process, and HARQ retransmission sensitive to delayed transmission, for example.

Great transmission delay will make the Round Trip Time (RTT) of HARQ transmission longer, and too long stopping and waiting time will seriously reduce the data transmission rate. In order to improve the data transmission rate, one method is to support a large number of parallel HARQ processes, but this is difficult to support in hardware and software, and the other method is to turn off the HARQ feedback function, which will affect the reliability of data transmission.

The present disclosure provides a method performed by a user terminal UE. The user terminal UE receives information related to whether a hybrid automatic repeat request HARQ feedback function is disabled or not, and receives downlink control information and a shared channel scheduled by the downlink control information based on the information, thereby improving the reliability of data transmission.

As an exemplary embodiment, in the method performed by a user terminal UE provided by the present disclosure, the reliability of data transmission is improved by blind retransmissions. Specifically, receiving downlink control information DCI for scheduling a physical downlink shared channel PDSCH or a physical uplink shared channel PUSCH by the user terminal UE, receiving DCI for scheduling blind retransmissions of the PDSCH or PUSCH at least once at the soonest during a time interval since receiving the DCI for scheduling the PDSCH or PUSCH and less than round trip time RTT, and combining and decoding the PDSCH and its blind retransmissions by the user terminal UE or by the base station, thus improving the reliability of data transmission.

As an exemplary embodiment, in the method performed by the user terminal UE provided by the present disclosure, the reliability of data transmission is also improved by means of slot aggregation transmission. Specifically, the user terminal UE receives downlink control information DCI for scheduling a physical downlink shared channel PDSCH or a physical uplink shared channel PUSCH, and the DCI for scheduling the PDSCH contains a field for indicating a number of slots of the scheduled PDSCH slot aggregation transmission, thereby improving the reliability of data transmission.

As an exemplary embodiment, in the method performed by the user terminal UE provided by this disclosure, more HARQ processes can be indicated without increasing the size of the HPN indication field by combining implicit information and explicit information to jointly indicate the HPN. Specifically, in this disclosure, the HARQ process number HPN can include explicit information and implicit information. The explicit information is indicated by the field for indicating HPN contained in the received DCI, and the implicit information is indicated by at least one of the following ways: implicitly indicating by monitoring PDCCH using different cell radio network temporary identification C-RNTI values; implicitly indicating by monitoring physical downlink control channel PDCCH in different PDCCH search spaces; implicitly indicating by monitoring PDCCH in different slots; or implicitly indicating by monitoring PDCCH in different frequency domain resources.

In addition, at present, the details about blind retransmissions of PDSCH or PUSCH, PDSCH or PUSCH slot aggregation transmission, and information related to whether a hybrid automatic repeat request HARQ feedback function is disabled, are not clear, and the embodiments of this disclosure at least partially solve the above technical problems.

Please refer to FIG. 4. FIG. 4 illustrates a flowchart of a method performed by a user equipment UE according to an embodiment of the present disclosure. The method performed by a user terminal UE comprises steps S410 and S420.

In step S410, the user terminal UE may receive information related to whether a hybrid automatic repeat request HARQ feedback function is disabled.

There are multiple implementation of the information related to whether the hybrid automatic repeat request HARQ feedback function is disabled, which will be described in connection with the drawings and embodiments below.

In step S420, based on the information, the user terminal UE may receive downlink control information and the shared channel scheduled by the downlink control information.

The shared channel may be a physical downlink shared channel PDSCH or a physical uplink shared channel PUSCH. In the subsequent embodiments, the physical downlink shared channel PDSCH is mainly taken as an example, but it can be understood that the solution about the physical uplink shared channel PUSCH is also within the scope to be protected by this disclosure, and the detailed explanation is omitted for the sake of brevity.

The user terminal UE may receive information related to whether a hybrid automatic repeat request HARQ feedback function is disabled or not, and receive downlink control information and a shared channel scheduled by the downlink control information based on the information, thereby improving the reliability of data transmission.

The following describes in detail the blind retransmissions and its implementation details in the method performed by the user terminal UE provided by this disclosure with reference to the accompanying drawings.

Taking PDSCH as an example, if the HARQ feedback function of PDSCH is disabled, the base station cannot decide whether to retransmit PDSCH based on HARQ feedback, and can only retransmit PDSCH blindly. That is, the UE will also receive at least one blind retransmission of the PDSCH after receiving the initial transmission of the PDSCH, and the combining of the initial transmission and the blind retransmission of the PDSCH by the UE can improve the decoding performance of the PDSCH. Here, the UE may not feedback the corresponding HARQ-ACK for the initial transmission and/or blind retransmission of PDSCH.

The difference between blind retransmission and retransmission based on HARQ feedback is that the earliest transmission time can be different, and retransmission based on HARQ feedback must meet the RTT requirement, that is, the interval between initial transmission and retransmission must be greater than or equal to RTT, while blind retransmission has no such restriction, and the interval between initial transmission and retransmission can be smaller than RTT, thus improving the data transmission rate.

The following describes in detail the method performed by the user terminal UE provided by this disclosure with reference to the FIG. 5.

Please refer to FIG. 5. FIG. 5 illustrates a part of flowchart of a method performed by a user equipment UE according to an embodiment of the present disclosure.

In step S510, the user terminal UE may receive downlink control information DCI for scheduling a physical downlink shared channel PDSCH or a physical uplink shared channel PUSCH.

As an implementation, the UE may perform blind retransmission when the hybrid automatic repeat request HARQ feedback function is disabled. Specifically, the UE may perform step S510 if the information related to whether the hybrid automatic repeat request HARQ feedback function is disabled indicates that the HARQ feedback function is disabled.

In step S520, the user terminal UE may receive DCI for scheduling blind retransmissions of the PDSCH or PUSCH at least once at the soonest during a time interval since receiving DCI for scheduling the PDSCH or PUSCH and less than round trip time RTT.

Herein, blind retransmissions refer to retransmissions that are not based on hybrid automatic repeat request HARQ feedback.

The reliability of data transmission is improved by way of performing blind retransmissions by the user equipment UE, in particular, by receiving the downlink control information DCI for scheduling a physical downlink shared channel PDSCH or a physical uplink shared channel PUSCH, and receiving the DCI for scheduling blind retransmissions of the PDSCH or PUSCH at least once at the soonest during a time interval since receiving the DCI for scheduling the PDSCH or PUSCH and less than the round trip time RTT.

Optionally, the above blind retransmissions may be configurable, for example, may be configured by system information or UE-specific radio resource control RRC signaling.

Specifically, as an implementation, the method performed by the user terminal UE may further comprise: receiving system information, which is used to indicate the blind retransmission configuration or to respectively indicate the blind retransmission configuration of each hybrid automatic repeat request HARQ process.

As another implementation, the method performed by the user terminal UE may further comprise: receiving UE-specific radio resource control (RRC) signaling, which is used to indicate the blind retransmission configuration of the UE or respectively indicate the blind retransmission configuration of each hybrid automatic repeat request HARQ process of the UE.

The configuration and use of blind retransmissions become more flexible by configuring the blind retransmissions in the above various ways.

Optionally, the above blind retransmission can only be used for HARQ processes with the HARQ feedback function disabled. For example, the HARQ processes with the HARQ feedback function disabled can be configured to perform blind retransmission, or can perform blind retransmission by default.

By configuring the HARQ processes with HARQ feedback function disabled to be able to perform blind retransmission, the problem that the disabling the HARQ feedback function affects the reliability of data transmission is improved, and the blind retransmission is configured only for the HARQ processes with HARQ feedback function disabled, so that the data transmission amount of other HARQ processes without HARQ feedback function disabled will not be affected.

Optionally, blind retransmissions of PDSCH and PDSCH retransmissions based on

HARQ feedback can be used jointly. Please refer to FIG. 6, which illustrates a schematic diagram of the joint use of blind retransmissions of PDSCH and PDSCH retransmissions based on HARQ feedback.

As shown in FIG. 6, when the number of blind retransmissions of the PDSCH received by the UE reaches the maximum number of retransmissions, the hybrid automatic repeat request HARQ feedback is transmitted to the base station, and the base station can decide whether to retransmit the PDSCH after receiving the HARQ feedback. In FIG. 6, the base station retransmits the PDSCH again after receiving the HARQ feedback, so the UE receives the retransmission based on the HARQ feedback.

Herein, the maximum number of retransmissions is a predefined value or a value configured by radio resource control RRC signaling or media access control control element MAC CE.

The reliability of data transmissions can be further improved by the above-mentioned blind retransmissions of PDSCH and PDSCH retransmissions based on HARQ feedback.

Optionally, the DCI for scheduling PDSCH or PUSCH includes a field for indicating whether there are blind retransmissions after the scheduled PDSCH or PUSCH, and the method performed by the user terminal UE may further include steps S610 to S630. Specifically, please refer to FIG. 7, which illustrates a part of flowchart of a method performed by a user equipment UE according to an embodiment of the present disclosure.

In step S610, based on the DCI for scheduling PDSCH or PUSCH including a field for indicating whether there are blind retransmissions after the scheduled PDSCH or PUSCH, the user terminal UE may determine whether there are blind retransmissions after the scheduled PDSCH.

Herein, the scheduled PDSCH or PUSCH includes the initial transmissions or blind retransmissions of the scheduled PDSCH or PUSCH.

If the DCI for scheduling the PDSCH or PUSCH indicates that there is no blind retransmission after the scheduled PDSCH or PUSCH, step S620 is performed, and the buffered data corresponding to the PDSCH or PUSCH is flushed no matter whether the PDSCH or PUSCH is successfully decoded.

In step S630 is performed if the DCI for scheduling the PDSCH or PUSCH indicates that there are blind retransmissions after the scheduled PDSCH or PUSCH, and if the PDSCH or PUSCH is not successfully decoded, the user terminal UE may keep the buffered data corresponding to the PDSCH or PUSCH. In this way, the storage resources of the UE can be utilized more effectively, and the UE can further improve the decoding performance of the PDSCH by combining the initial transmissions and blind retransmissions of the PDSCH. In addition, it can be understood that after transmitting the PUSCH, the UE will also buffer the buffered data corresponding to the PUSCH. Therefore, for blind retransmissions of the PUSCH, by flushing the buffered data corresponding to the PUSCH, the storage resources of the UE can be used more effectively.

Optionally, the DCI for scheduling PDSCH or PUSCH includes the number of blind retransmissions after the scheduled PDSCH or PUSCH, for example, the number of blind retransmissions can be 0, 1, 2, 4, etc., which is not limited by this disclosure.

If the DCI for scheduling PDSCH indicates that the number of blind retransmissions after the scheduled PDSCH is 0, the UE flushes the buffered data corresponding to the PDSCH no matter whether the PDSCH is successfully decoded or not; if the DCI for scheduling the PUSCH indicates that the number of blind retransmissions after the scheduled PUSCH is 0, then the buffered data corresponding to the PUSCH is flushed after transmitting the PUSCH.

The buffered data corresponding to the scheduled PDSCH or PUSCH is flushed when the number of blind retransmissions after the scheduled PDSCH or PUSCH indicated in the DCI is 0, so that there is no additional requirement on the buffer size and software and hardware capabilities of the UE.

Optionally, the number or maximum number of blind retransmissions of the PDSCH or PUSCH is a predefined value, or a value configured by radio resource control RRC signaling or media access control control element MAC CE. For example, the number or maximum number of blind retransmissions of PDSCH or PUSCH can be 0, 1, 2, 4, etc., which is not limited by this disclosure.

If the radio resource control RRC signaling or the media access control control element MAC CE indicates that the number of blind retransmissions of the PDSCH or PUSCH is 0, the UE flushes the buffered data corresponding to the scheduled PDSCH or PUSCH no matter whether the PDSCH or PUSCH can be decoded correctly or not.

By flushing the buffered data corresponding to the scheduled PDSCH or PUSCH when the number of blind retransmissions after the scheduled PDSCH or PUSCH indicated in the radio resource control RRC signaling or the media access control control element MAC CE is 0, there is no additional requirement on the buffer size and software and hardware capabilities of the UE.

Optionally, the number or maximum number of blind retransmissions may be different for each automatic retransmission request HARQ process. That is, the base station can configure the number or maximum number of blind retransmissions for each HARQ process, respectively. Of course, it can be understood that the number or maximum number of blind retransmissions may be the same for each automatic repeat request HARQ process.

Optionally, when the number of received blind retransmissions of the PDSCH reaches the maximum number of blind retransmissions, the buffered data corresponding to the PDSCH is flushed no matter whether the PDSCH is successfully decoded or not; or when the number of received blind retransmissions of the PUSCH reaches the maximum number of blind retransmissions, the buffered data corresponding to the PUSCH is flushed after the last blind retransmission of the PUSCH is transmitted.

By flushing the buffered data corresponding to the scheduled PDSCH when the number of received blind retransmissions of the PDSCH by the UE reaches the maximum number of blind retransmissions, the storage resources of the UE can be utilized more effectively.

Optionally, it may meet the requirements of the minimum time interval between the DCI for scheduling PDSCH or PDSCH, or the PUSCH or PUSCH, and the DCI for scheduling blind retransmissions of the PDSCH or PUSCH, or the blind retransmissions of the PDSCH or PUSCH. The minimum time interval is related to the processing time of the PDSCH or PUSCH and can be predefined or preconfigured. The advantage of setting the minimum time interval is that the UE can release the corresponding buffered data to receive the next blind retransmission of the PDSCH after completing the reception processing of the PDSCH or the transmission processing of the PUSCH, so there is no additional requirement on the buffer size and software and hardware capabilities of the UE.

Optionally, it may meet the requirements of the maximum time interval between the DCI for scheduling PDSCH or PDSCH, or the PUSCH or PUSCH, and the DCI for scheduling blind retransmissions of the PDSCH or PUSCH, or the blind retransmissions of the PDSCH or PUSCH. The maximum time interval may be related to the RTT of the PDSCH or PUSCH and can be predefined or preconfigured. The advantage of setting the maximum time interval is that if the UE has never received the blind retransmission of the same PDSCH, the UE should flush the buffered data corresponding to the PDSCH after the maximum time interval, so there is no additional requirement on the buffer size and software and hardware capabilities of the UE.

Optionally, the UE may monitor blind retransmissions of PDSCH or PUSCH within a time window after DCI for scheduling PDSCH or PUSCH or after the PDSCH or PUSCH. The length of the time window may be related to RTT of the PDSCH or PUSCH, which may be predefined or preconfigured. The starting position of the time window may be predefined. For example, the time window starts from a predefined interval after the PDSCH or PUSCH transmission. The advantage of setting a time window is that if the UE does not receive the PDSCH blind retransmission within the time window, the UE should flush the buffered data corresponding to the PDSCH, so there is no additional requirement on the buffer size and software and hardware capabilities of the UE.

As a specific implementation of the above concept, optionally, the method performed by the user terminal UE may further comprise:
receiving at least one of the following indication information:
information indicating a time interval, a first minimum time interval or a first maximum time interval between the DCI for scheduling the PDSCH or PUSCH and the DCI for scheduling the blind retransmissions of the PDSCH or PUSCH;
information indicating a time interval, a second minimum time interval or a second maximum time interval between the PDSCH or PUSCH and the DCI for scheduling the blind retransmissions of the PDSCH or PUSCH;
information indicating a time interval, a third minimum time interval or a third maximum time interval between the PDSCH or PUSCH and the blind retransmissions of the PDSCH or PUSCH; or
information indicating a time window for monitoring the blind retransmissions of the PDSCH or PUSCH, wherein a starting position of the time window is a position with a predefined or preconfigured interval after the DCI for scheduling the PDSCH or PUSCH, or a position with a predefined or preconfigured interval after the PDSCH or PUSCH;
wherein at least one of the indication information is indicated by the DCI for scheduling the PDSCH or PUSCH, radio resource control RRC signaling or media access control control element MAC CE.

It can be understood that, for example, the above-mentioned indicated time interval between DCI for scheduling PDSCH or PUSCH and DCI for scheduling blind retransmissions of the PDSCH or PUSCH refers to the time interval between DCI for scheduling PDSCH and DCI for scheduling blind retransmissions of the PDSCH, or between DCI for scheduling PUSCH and DCI for scheduling blind retransmissions of the PUSCH

For example, the indicated time interval between the PDSCH or PUSCH and DCI for scheduling blind retransmissions of the PDSCH or PUSCH refers to the time interval between the PDSCH and DCI for scheduling blind retransmissions of the PDSCH, or between the PUSCH and DCI for scheduling blind retransmissions of the PUSCH.

For example, the above indicated time interval between the PDSCH or PUSCH and the blind retransmissions of the PDSCH or PUSCH refers to the time interval between the PDSCH and the blind retransmissions of the PDSCH, or between the PUSCH and the blind retransmissions of the PUSCH. Further, optionally, the method performed by the user terminal UE may further comprise:
if the UE does not receive DCI for scheduling blind retransmissions of PDSCH or PUSCH within the first maximum time interval since receiving DCI for scheduling the PDSCH or PUSCH;
or, if the DCI for scheduling blind retransmissions of the PDSCH is not received within the second maximum time interval since the PDSCH;
or, if the blind retransmissions of the PDSCH is not received within the third maximum time interval since the PDSCH;
or, if the blind retransmissions of the PDSCH is not monitored within the time window for monitoring the blind retransmissions of the PDSCH;
flushing the buffered data corresponding to the PDSCH or PUSCH.

Optionally, the time interval between DCI for scheduling the PDSCH or PUSCH and DCI for scheduling the blind retransmissions of the PDSCH or PUSCH, the time interval between the PDSCH or PUSCH and DCI for scheduling the blind retransmissions of the PDSCH or PUSCH, and the time interval between the PDSCH or PUSCH and the blind retransmissions of the PDSCH or PUSCH, can be the same or different.

Optionally, the first minimum time interval, the second minimum time interval and the third minimum time interval may be the same or different.

Optionally, the first maximum time interval, the second maximum time interval and the third maximum time interval may be the same or different.

Optionally, the PDSCH or PUSCH includes semi-persistent scheduling (SPS) PDSCH or PUSCH. That is, semi-persistent scheduling PDSCH or PUSCH can also support the blind retransmission function, that is, after receiving SPS PDSCH, UE may receive blind retransmissions of the PDSCH based on dynamic scheduling.

Optionally, the UE only feeds back HARQ-ACK to the initial transmissions of PDSCH, and does not feedback HARQ-ACK to the retransmissions of the PDSCH (including blind retransmissions or retransmissions based on HARQ-ACK feedback). The advantage of this method is to make a compromise between reliability and transmission delay.

Optionally, the above similar solution can also be used for uplink, for example, scheduling physical uplink shared channel PUSCH also supports blind retransmission function. As a specific implementation, the method performed by the user terminal UE may further comprise:
receiving downlink control information DCI for scheduling a physical uplink shared channel PUSCH;
receiving DCI for scheduling blind retransmissions of the PUSCH at least once at the soonest during a time interval since receiving DCI for scheduling the PUSCH and less than round trip time RTT.

Particularly, after receiving the downlink control information DCI for scheduling the physical uplink shared channel PUSCH and before transmitting the PUSCH, the UE may receive the blind retransmission scheduling of the PUSCH; particularly, it needs to meet a predefined or preconfigured minimum interval between the downlink control information DCI for scheduling the physical uplink shared channel PUSCH received by the UE and the DCI for scheduling the blind retransmissions of the PUSCH; particularly, it needs to meet a predefined or preconfigured maximum interval between the downlink control information DCI for scheduling the physical uplink shared channel PUSCH received by the UE and the DCI for scheduling the blind retransmissions of the PUSCH.

Next, the time slot aggregation transmission and its implementation details in the method performed by the user terminal UE provided by this disclosure will be described in detail with reference to the accompanying drawings.

Taking PDSCH as an example, because the duration of HARQ RTT is too long, the HARQ feedback function of PDSCH is disabled, so the base station cannot decide whether to retransmit PDSCH based on HARQ feedback. In order to improve the decoding performance of PDSCH, the base station can transmit PDSCH through a way of slot aggregation.

PDSCH slot aggregation transmission refers to that PDSCH is transmitted across multiple slots, that is, PDSCH occupies the same time-frequency resources in multiple slots for transmission, PDSCH can be transmitted in multiple slots based on repetition, and PDSCH in each slot can be decoded independently. UE can improve decoding performance in terms of improving signal-to-noise ratio by combining PDSCH in multiple slots. This slot aggregation can also be called repetition. Or, PDSCH can be transmitted in multiple slots based on overall rate matching. Here, PDSCH in a single slot cannot be decoded independently, and UE can improve decoding performance in terms of reducing code rate by receiving PDSCH in all slots.

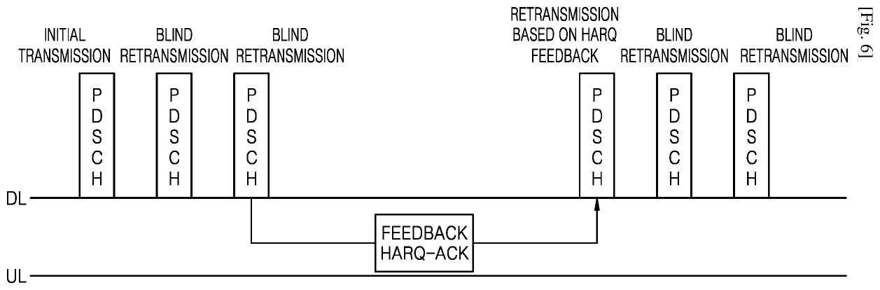

As a specific implementation, please refer to FIG. 8, which illustrates a part of flowchart of a method performed by a user equipment UE according to an embodiment of the present disclosure. The method performed by the user terminal UE may further comprise:

In step S710, the user equipment UE may receive downlink control information DCI for scheduling a physical downlink shared channel PDSCH or a physical uplink shared channel PUSCH, wherein the DCI for scheduling the PDSCH or PUSCH may contain a field for indicating a number of slots for the scheduled PDSCH or PUSCH slot aggregation transmission.

Herein, a size of the field for indicating the number of slots for the scheduled PDSCH or PUSCH slot aggregation transmission in the DCI for scheduling the PDSCH or PUSCH is determined by a maximum number of slots for the scheduled PDSCH or PUSCH slot aggregation transmission, which is configured via radio resource control RRC signaling or media access control control element MAC CE.

It can be understood that the above step S710 can be performed when the information related to whether the hybrid automatic repeat request HARQ feedback function is disabled or on indicates that the HARQ feedback function is disabled or on. That is, no matter whether the HARQ feedback function is disabled or enabled, the above PDSCH or PUSCH slot aggregation transmission can be performed.

Optionally, the maximum number of slots may be respectively configured for at least one of each quality of service QoS of PDSCH or PUSCH, each hybrid automatic repeat request HARQ process of the PDSCH or PUSCH, each logical channel of the PDSCH or PUSCH, each priority of the PDSCH or PUSCH, each scheduling method of the PDSCH or PUSCH (herein, the scheduling method includes dynamic scheduling and semi-persistent scheduling), or whether HARQ feedback function of the PDSCH or PUSCH is enabled.

Optionally, both PDSCH or PUSCH with HARQ feedback function disabled and PDSCH or PUSCH with HARQ feedback function enabled can be transmitted by slot aggregation, but the respective used number or maximum number of aggregation slots can be different. For example, the base station configures the number or maximum number of aggregation slots for PDSCH or PUSCH with HARQ feedback function disabled and PDSCH or PUSCH with HARQ feedback function enabled respectively through radio resource control RRC signaling or media access control control element MAC CE.

Optionally, there may be a certain interval between slots for PDSCH or PUSCH slot aggregation transmission, that is, multiple slots for PDSCH slot aggregation transmission are discontinuous.

Optionally, there is the same interval between each slot or each slot bundle among multiple slots for PDSCH or PUSCH slot aggregation transmission, herein the slot bundle refers to two or more consecutive slots. In this way, time diversity gain can be obtained, and the base station can schedule multiple UEs together, that is, PDSCH or PUSCH aggregation slot transmission of multiple UEs is interleaved in time, and the interval between aggregation slots also becomes an interleaving interval.

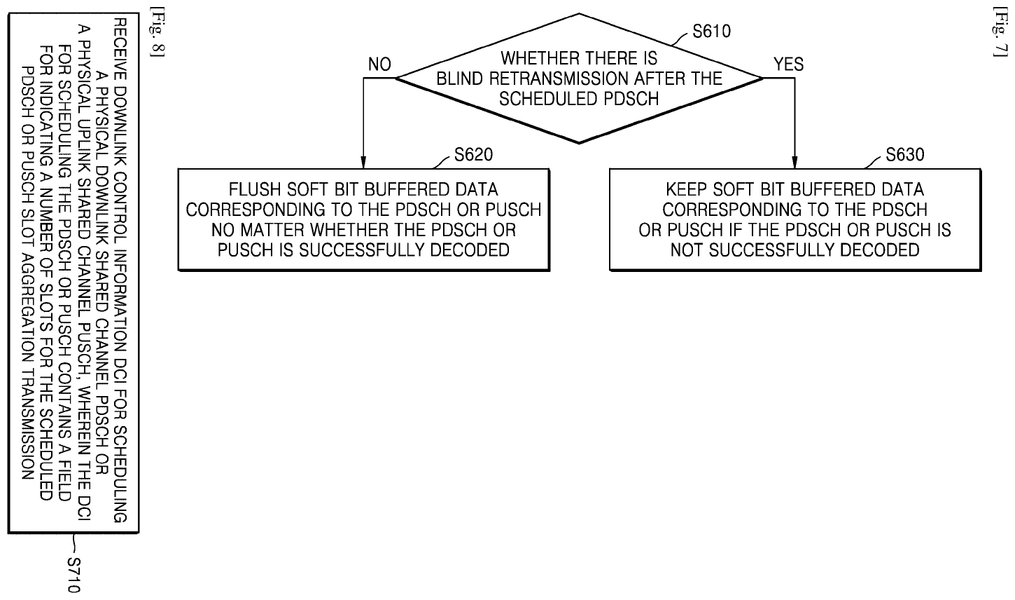

Please refer to FIG. 9, which illustrates a schematic diagram of cross distribution of aggregation slots of three UEs in time according to an embodiment of the present disclosure. As shown in FIG. 9, the aggregation slots of the three UEs are cross-distributed in time, thereby improving the time diversity gain.

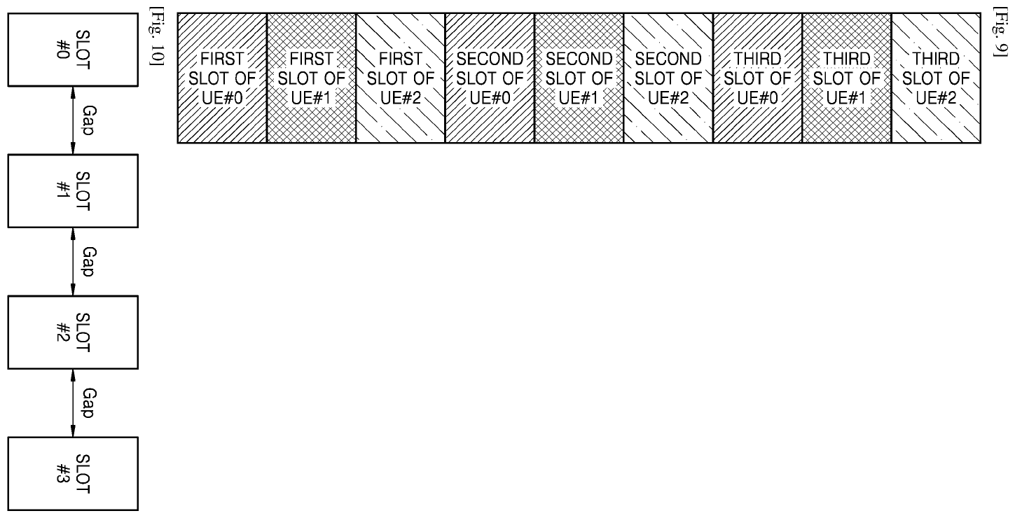

Next, the interval between each slot or between each slot bundle among a plurality of slots for PDSCH slot aggregation transmission will be described with reference to FIG. 10 and FIG. 11, respectively.

Please refer to FIG. 10, which illustrates a schematic diagram of an interval between each slot among a plurality of slots for PDSCH slot aggregation transmission according to an embodiment of the present disclosure.

As shown in FIG. 10, PDSCH is transmitted on four aggregation slots, and there is a certain time interval between every two adjacent slots, and the sizes of the intervals are the same, all of which are Gap.

Please refer to FIG. 11, which illustrates a schematic diagram of an interval between each slot bundle among a plurality of slots for PDSCH slot aggregation transmission according to an embodiment of the present disclosure.

As shown in FIG. 11, PDSCH is transmitted on 8 aggregation slots, and every two adjacent slots form a slot bundle, and there is a certain time interval between every two slot bundles, and the sizes of the intervals are the same, all of which are Gap.

In addition, whether there is an interleaving interval for PDSCH slot aggregation transmission and the size of the interleaving interval for PDSCH slot aggregation transmission are configurable.

Optionally, the method performed by the user terminal UE may further comprise:
receiving at least one of the following indication information:
information indicating whether there is an interval between each slot or between each slot bundle among the plurality of slots for the scheduled PDSCH or PUSCH slot aggregation transmission; or
information indicating a size of an interval between each slot or between each slot bundle among the plurality of slots for scheduled PDSCH or PUSCH slot aggregation transmission , for example, the interval may be 1 slot, 2 slots, 4 slots, etc.;
wherein at least one of the indication information is configured by DCI for scheduling PDSCH or PUSCH, radio resource control RRC signaling or media access control control element MAC CE.

As a specific embodiment, for example, the base station can preconfigure whether there is an interleaving interval for PDSCH or PUSCH slot aggregation transmission through radio resource control RRC signaling or media access control control element MAC CE. When PDSCH or PUSCH slot aggregation transmission is configured to have an interleaving interval, the base station can further configure the size of the interleaving interval. Or, DCI for scheduling PDSCH or PUSCH slot aggregation dynamically indicates whether there is an interleaving interval between aggregation slots, and the size of the interleaving interval between aggregation slots can be predefined or preconfigured by radio resource control RRC signaling or media access control control element MAC CE.

In another example, the base station can preconfigure the size of the interleaving interval for PDSCH or PUSCH slot aggregation through radio resource control RRC signaling or media access control control element MAC CE, for example, the interval is 1 slot, 2 slots, 4 slots, etc. Or, DCI for scheduling PDSCH or PUSCH slot aggregation dynamically indicates the size of interleaving interval between aggregation slots. A set of configurable sizes of interleaving intervals between aggregation slots may be predefined or preconfigured by radio resource control RRC signaling or media access control control element MAC CE.

In this way, the base station can dynamically schedule the PDSCH or PUSCH slot aggregation transmission to be continuous or with an interleaving interval.

In addition, the size of the slot bundle for interleaving for PDSCH or PUSCH slot aggregation transmission may also be configurable. Optionally, the size of the slot bundle is configured by DCI for scheduling PDSCH or PUSCH, radio resource control RRC signaling or media access control control element MAC CE. For example, the base station can configure the size of the slot bundle for interleaving for PDSCH or PUSCH slot aggregation transmission through radio resource control RRC signaling or media access control control element MAC CE, such as one slot, two slots, four slots, etc. Or, the size of the slot bundle for interleaving is dynamically indicated by DCI for scheduling PDSCH or PUSCH. A set of configurable sizes of slot bundles for interleaving for PDSCH or PUSCH aggregation slot transmission can be predefined or preconfigured by the medium access control control element MAC CE.

For PDSCH or PUSCH slot aggregation transmission, because the number of aggregation slots is large, or the size of interleaving interval between aggregation slots is large, it is possible to indicate that a certain slot in aggregation slots is an uplink slot or an unavailable slot in the subsequently received DCI indicating slot format indicator (SFI), so it is a problem whether UE can still transmit on these slots.

To solve the above problems, optionally, the method performed by the user terminal UE provided by the present disclosure may further comprise:

When the slot for the scheduled PDSCH or PUSCH slot aggregation transmission is identified as an unavailable slot, the UE discards the signal that should be mapped to the slot or maps it to the next available slot.

It can be understood that all the above-mentioned design solutions related to PDSCH aggregation slot transmission can be applied to PUSCH in the same way, and will not be described again.

This disclosure has also made some improvements in the details of disabling HARQ feedback. The implementation details of disabling HARQ feedback in the method performed by the user terminal UE provided by this disclosure will be described in detail with reference to the drawings.

As mentioned earlier, because the RTT duration of HARQ is too long, in order to improve the transmission efficiency, the HARQ feedback function is disabled.

Optionally, the information related to whether the hybrid automatic repeat request HARQ feedback function is disabled or not received in step S410 of FIG. 4 may include at least one of the following information:
information indicating a number of downlink DL HARQ processes with the hybrid automatic repeat request HARQ feedback function disabled;
information indicating a number of DL HARQ processes with the HARQ feedback function enabled; or
information indicating a total number of DL HARQ processes including the number of DL HARQ processes with the HARQ feedback function disabled and the number of DL HARQ processes with the HARQ feedback function enabled;
herein, at least one of the information is configured by radio resource control RRC signaling or media access control control element MAC CE.

Optionally, the information related to whether the hybrid automatic repeat request HARQ feedback function is disabled or not received in step S410 of FIG. 4 is related to the HARQ process number HPN, and the PDSCH transmission with the HARQ feedback function enabled and the PDSCH transmission with the HARQ feedback function disabled use different HARQ processes. The method performed by the user terminal UE provided by the present disclosure may further comprise: determining whether the HARQ feedback function of the corresponding HARQ process is disabled based on the HARQ process number HPN.

Optionally, the DL HARQ processes with the HARQ feedback function enabled use continuous HARQ process numbers, which increase from the smallest HARQ process number or decrease from the largest HARQ process number.

As a specific implementation, PDSCH with HARQ feedback function enabled and PDSCH with HARQ feedback function disabled can use different HARQ processes, and the base station can configure the number of DL HARQ processes with HARQ feedback function enabled through radio resource control RRC signaling or media access control control element MAC CE. And the DL HARQ processes with the HARQ feedback function enabled use continuous HARQ Process Numbers (HPNs) by default, for example, increasing from the smallest HARQ process number, that is, the HPN indication value increases from 0; or, decreasing from the largest HARQ process number, assuming that the total number of HARQ processes is N, that is, the HPN indication value decreases from N-1. In this way, the UE can know which process numbers are used for transmission of PDSCH with HARQ feedback function enabled according to the number of DL HARQ processes with HARQ feedback function enabled configured by radio resource control RRC signaling or media access control element MAC CE, so as to determine whether the corresponding HARQ feedback function is disabled according to the received HPN indication in DCI.

For example, assuming that the total number of DL HARQ processes is 16, the size of HPN indication field in DCI is 4 bits, and the number of DL HARQ processes with HARQ feedback function enabled configured by radio resource control RRC signaling or media access control control element MAC CE is 4, then when the HPN indication value is 0000, 0001, 0010, 0011, it is determined that PDSCH of corresponding HARQ processes supports HARQ feedback, while when HPN indicates other values, it is determined that PDSCH of corresponding HARQ processes does not support HARQ feedback.

Optionally, the information related to whether the hybrid automatic repeat request HARQ feedback function is disabled received in step S410 of FIG. 4 may include: information respectively indicating whether each downlink DL HARQ process supports HARQ feedback, wherein the information is configured by radio resource control RRC signaling or media access control control element MAC CE.

Optionally, the maximum number of HARQ processes with the HARQ feedback function disabled is N-1, where N is the total number of HARQ processes.

Optionally, HARQ processes with HPN indication value of 0 or N-1 always turn on HARQ feedback function by default, where N is the total number of HARQ processes, that is, the HARQ feedback function of the first or last HARQ process is always enabled by default.

Optionally, the base station configures corresponding sets of DL HARQ process numbers for PDSCH with HARQ feedback function enabled and PDSCH with HARQ feedback function disabled through radio resource control RRC signaling or media access control control element MAC CE, in other words, whether to support HARQ feedback is separately configured by the base station for each DL HARQ process.

Optionally, PDSCH transmission with the HARQ feedback function disabled only occupies one downlink DL HARQ process, and it is specified that the indication value of HPN of the HARQ process is 0 or N-1, where N is the total number of HARQ processes.

Optionally, receiving information related to whether the hybrid automatic repeat request HARQ feedback function is disabled in step S410 of FIG. 4 can be specifically implemented as: receiving radio resource control RRC signaling or media access control element MAC CE for configuring information of downlink DL HARQ process with the HARQ feedback function disabled, and receiving downlink control information DCI containing information indicating whether HARQ feedback is required for current PDSCH transmission in the DL HARQ process.

Optionally, when the HARQ process with downlink DL HARQ feedback function disabled or the enabled is used for semi-persistent scheduling SPS PDSCH transmission, it is determined whether HARQ feedback needs to be performed according to the enable/disable configuration of the HARQ feedback function of corresponding SPS PDSCH.

Particularly, the above-mentioned configuring on/off of the DL HARQ feedback function for each HARQ process number is not only applicable to dynamically scheduled PDSCH, but also applicable to semi-persistent scheduling (SPS) PDSCH. For example, assuming that the HARQ feedback function of DL HARQ process number #n is disabled, no matter whether the HARQ process number is used for dynamically scheduled PDSCH transmission or SPS PDSCH transmission, the UE does not need to feedback ACK/NACK, but it is still necessary for the UE to feed back ACK for the DCI indicating SPS transmission activation or resource release.

The above-mentioned configuring on/off of DL HARQ feedback function for each HARQ process number is only applicable to dynamically scheduled PDSCH, but not to semi-persistent scheduling (SPS) PDSCH. For SPS PDSCH, the base station can configure the on/off of the DL HARQ feedback function for each configured SPS PDSCH through higher layer signaling (RRC signaling or MAC CE). Especially, even if the HARQ feedback function of SPS PDSCH is disabled, it is still necessary for the UE to feedback ACK for DCI indicating SPS transmission activation or resource release. For example, assuming that the HARQ feedback function of DL HARQ process number #n is disabled, the UE does not need to feed back ACK/NACK only when the HARQ process number is used for dynamically scheduled PDSCH transmission, but when the HARQ process number is used for SPS PDSCH transmission, the UE decides whether to perform HARQ feedback according to the enable/disable configuration of the HARQ feedback function of the corresponding SPS PDSCH, that is, the UE may need to feed back ACK/NACK.

When the DL HARQ feedback function is disabled, DCI fields related to HARQ feedback in DCI are all unnecessary, such as PUCCH resource indication field, PUCCH transmission power control indication field, etc. These indication fields can be reinterpreted to indicate other information, e.g., indicating one or more of the number of PDSCH blind retransmissions, whether PDSCH has a next blind retransmission, the interval with the next blind retransmission of PDSCH, the minimum interval with the next blind retransmission of PDSCH, the maximum interval with the next blind retransmission of PDSCH, the monitoring time window for the next blind retransmission of PDSCH, the number of PDSCH aggregation slots, and the interleaving interval of PDSCH aggregation slots.

Optionally, the information related to whether the hybrid automatic repeat request HARQ feedback function is disabled or not received in step S410 of FIG. 4 includes DCI for scheduling PDSCH with HARQ feedback function enabled and DCI for scheduling PDSCH with HARQ feedback function disabled, and both have the same DCI format, i.e., have the same DCI payload size, and it is determined whether the corresponding PDSCH needs to perform HARQ feedback by at least one of the following methods:
(1) monitoring physical downlink control channel PDCCH by using different cell radio network temporary identification C-RNTI values to determine whether the corresponding PDSCH needs to perform HARQ feedback.

For example, different RNTI values can be used for scrambling, and the UE is configured to determine whether the corresponding PDSCH needs to perform HARQ feedback by monitoring the physical downlink control channel PDCCH using different cell radio network temporary identification C-RNTI values.
(2) determining whether the corresponding PDSCH needs to perform HARQ feedback by monitoring PDCCH in different PDCCH search spaces.

For example, the UE monitors DCI with HARQ feedback function enabled and DCI with HARQ feedback function disabled in two different PDCCH search spaces to determine whether the corresponding PDSCH needs to perform HARQ feedback.
(3) determining whether the corresponding PDSCH needs to perform HARQ feedback by monitoring PDCCH in different slots.

For example, the UE monitors DCI with HARQ feedback function enabled and DCI with HARQ feedback function disabled in two different slot groups to determine whether the corresponding PDSCH needs to perform HARQ feedback.
(4) determining whether the corresponding PDSCH needs to perform HARQ feedback by monitoring PDCCH in different frequency domain resources.

For example, the UE monitors DCI with HARQ feedback function enabled and DCI with HARQ feedback function disabled in two different frequency domain resources to determine whether the corresponding PDSCH needs to perform HARQ feedback.
(5) determining whether the corresponding PDSCH needs to perform HARQ feedback according to the HARQ process number HPN.

For example, the UE determines whether the HARQ feedback function is enabled according to the HPN field in DCI to determine whether the corresponding PDSCH needs to perform HARQ feedback, that is, PDSCH with certain HPN indication values needs to feedback HARQ-ACK, while PDSCH with some HPN indication values does not need to feedback HARQ-ACK.
(6) determining whether the corresponding PDSCH needs to perform HARQ feedback through a specific field included in the downlink control information DCI for scheduling PDSCH.

For example, the dedicated field may be 1 bit.

Of course, this disclosure is not limited to the above implementations, and any implementation for determining whether the corresponding PDSCH needs to perform HARQ feedback belongs to the scope to be protected by this disclosure.

Optionally, the information related to whether the hybrid automatic repeat request HARQ feedback function is disabled or not received in step S410 of FIG. 4 includes DCI for scheduling PDSCH with HARQ feedback function enabled and DCI for scheduling PDSCH with HARQ feedback function disabled, and they have different DCI formats, i.e., different DCI payload sizes. The UE can decide whether the corresponding PDSCH needs to perform HARQ feedback according to the monitored DCI format.

In addition, this disclosure has also made some improvements in some details about HPN. The implementation details about HPN in the method performed by the user terminal UE provided by this disclosure will be described in detail with reference to the accompanying drawings.

Because the RRT duration of HARQ feedback is long, the data transmission rate can be increased by increasing the number of parallel HARQ processes. In order to support more HARQ processes without increasing the size of HPN indication field, implicit information can be used to help indicate HPN. Optionally, the HARQ process number HPN may include explicit information and implicit information, herein, the explicit information is indicated by the filed for indicating HPN contained in the received DCI, and the implicit information is indicated by at least one of the following ways:
(1) implicitly indicating by monitoring PDCCH using different cell radio network temporary identification C-RNTI values.

For example, the number of HARQ processes is increased to 32, and the HPN indication field in DCI uses the existing 4 bits. The UE is configured with two different C-RNTI values for HARQ processes with different HPN ranges, one for HARQ processes with HPN ranging from 0 to 15, and the other for HARQ processes with HPN ranging from 16 to 31.
(2) implicitly indicating by monitoring physical downlink control channel PDCCH in different PDCCH search spaces.

For example, the number of HARQ processes is increased to 32, the HPN indication field in DCI uses the existing 4 bits, and UE monitors HARQ processes with different HPN ranges in different PDCCH search spaces. One PDCCH search space is used for monitoring HARQ processes with HPN ranging from 0 to 15, and the other PDCCH search space is used for monitoring HARQ processes with HPN ranging from 16 to 31.
(3) implicitly indicating by monitoring PDCCH in different slots.

For example, the number of HARQ processes is increased to 32, the HPN indication field in DCI uses the existing 4 bits, and UE monitors HARQ processes with different HPN ranges in two set of different slots. One set of slots is used for monitoring HARQ processes with HPN ranging from 0 to 15, and the other set of slots is used for monitoring HARQ processes with HPN ranging from 16 to 31.
(4) implicitly indicating by monitoring PDCCH in different frequency domain resources.

For example, the number of HARQ processes is increased to 32, the HPN indication field in DCI uses the existing 4 bits, and UE monitors HARQ processes with different HPN ranges on two different frequency domain resources. One set of frequency domain resources is used for monitoring HARQ processes with HPN ranging from 0 to 15, and the other frequency domain resource is used for monitoring HARQ processes with HPN ranging from 16 to 31.

Of course, this disclosure is not limited to the above-mentioned implementations, and any implementation that jointly indicates HPN by combining implicit information with explicit information belongs to the scope to be protected by this disclosure.

By the above way of combining implicit information and explicit information to jointly indicate HPN, more HARQ processes can be indicated without increasing the size of HPN indication field.

It can be understood that when the information related to whether the hybrid automatic repeat request HARQ feedback function is disabled or on indicates that the HARQ feedback function is disabled or on, the above-mentioned indication mode of HARQ process number HPN can be used, that is, the above-mentioned indication mode of HARQ process number HPN is not limited to be used when the HARQ feedback function is disabled.

Next, a method performed by a base station in an embodiment of the present disclosure will be described with reference to FIG. 12, which illustrates a flowchart of a method performed by a base station according to an embodiment of the present disclosure, the method may comprise:

In step S810, the base station may transmit information related to whether the hybrid automatic repeat request HARQ feedback function is disabled or not.

Step S820, the base station may transmit downlink control information and a shared channel scheduled by the downlink control information.

The base station improves the reliability of data transmission by transmitting information related to whether the hybrid automatic repeat request HARQ feedback function is disabled, and transmitting downlink control information and a shared channel scheduled by the downlink control information.

It can be understood that the method performed by the base station is a method on the base station side corresponding to the above data transmission method performed by the terminal. For example, various types of DCI, system information, UE-specific radio resource control RRC signaling or radio resource control RRC signaling or media access control control element MAC CE or indication information and the like received by the terminal side are all configured or transmitted by the base station side. In the blind retransmission scheme, under certain conditions, the UE flushes the buffered data corresponding to PDSCH, and correspondingly, under certain conditions, the base station also has the corresponding operation of flushing the cached data corresponding to PUSCH. For the specific implementation details and advantageous effect, please refer to the corresponding description in the method for data transmission performed by the terminal, which will not be repeated here.

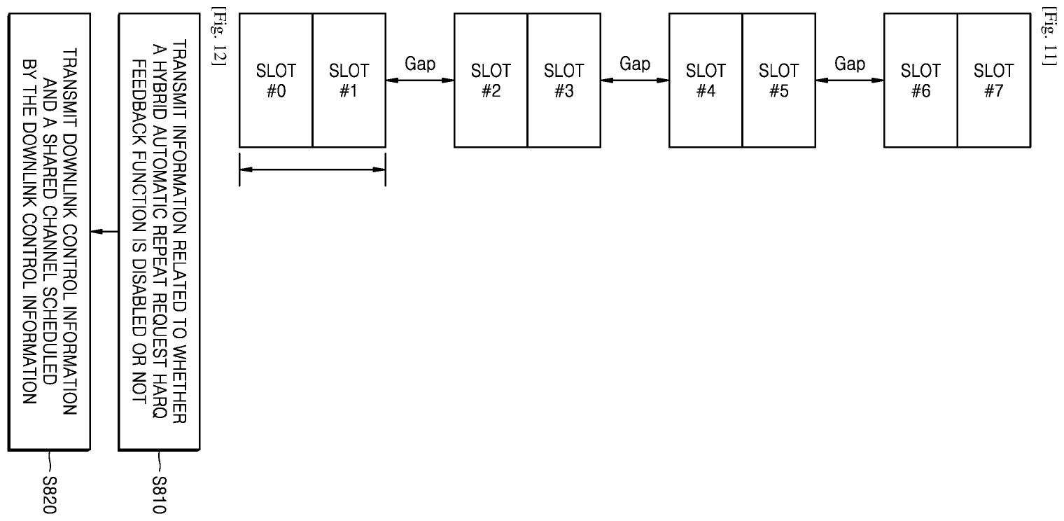

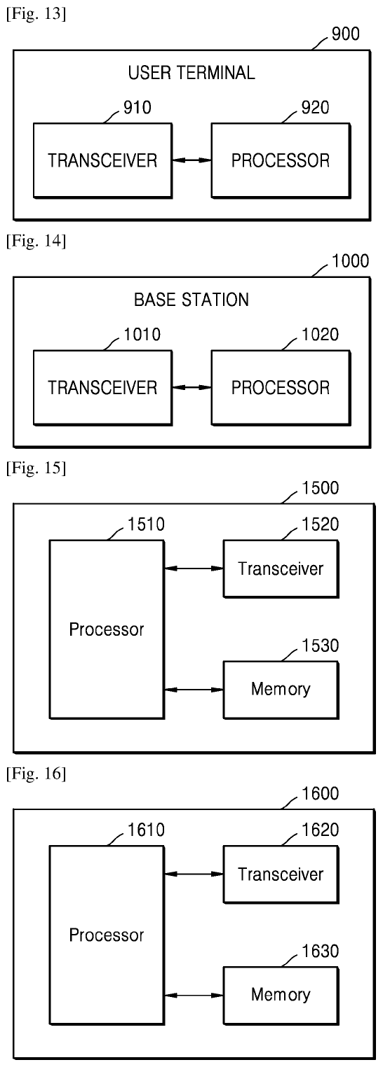

FIG. 13 is a block diagram showing the structure of a user terminal 900 according to an embodiment of the present disclosure.

Referring to FIG. 13, the user terminal 900 includes a transceiver 910 and a processor 920. The transceiver 910 is configured to transmit and receive signals to and from the outside. The processor 920 is configured to perform any of the above method performed by the user terminal. The user terminal 900 can be implemented in the form of hardware, software or a combination of hardware and software, so that it can perform the method for data transmission described in the present disclosure.

FIG. 14 is a block diagram showing the structure of a base station 1000 according to an embodiment of the present disclosure.

Referring to FIG. 14, a base station 1000 includes a transceiver 1010 and a processor 1020. The transceiver 1010 is configured to transmit and receive signals to and from the outside. The processor 1020 is configured to perform any of the above method performed by the base station. The base station 1000 can be implemented in the form of hardware, software or a combination of hardware and software, so that it can perform the method for data transmission described in the present disclosure.

FIG. 15 is a block diagram illustrating a structure of a user equipment 1500 according to an embodiment of the present disclosure.

As shown in FIG. 15, the UE 1500 may include a processor 1510, a transceiver 1530, and memory 1520. The memory 1520 stores instructions that, when executed by the processor 1510, cause the processor to perform the transmission method as described above with reference to FIGS. 1-24. However, components of the UE 1500 are not limited to the examples set forth above. For example, the UE may include more components or less components than the components set forth above. In addition, the processor 1510, the transceiver 1530, and the memory 1520 may be implemented in the form of one chip.

The processor 1510 may control a series of processes in which the UE 1500 may be operated according to the above-described embodiments of the disclosure. For example, the processor 1510 may control to transmit uplink control information to a base station. And, the processor 1510 may be at least one processor. The processor 1510 may control the transceiver 1530 to receive information related to whether a hybrid automatic repeat request, HARQ, feedback function is disabled or not. The processor 1510 may control the transceiver 1530 to receive downlink control information and a shared channel scheduled by the downlink control information, based on the information.

The transceiver 1530 may transmit a signal to and receive a signal from a gNB or another UE. The signal set forth above may include control information and data. For this purpose, the transceiver 1530 may include a radio frequency (RF) transmitter up-converting and amplifying a frequency of a transmitted signal, an RF receiver performing low-noise amplification and frequency down-conversion on a received signal, and the like. In addition, the transceiver 1530 may receive a signal through a radio channel and output the signal to the processor 1510, and may transmit, through the radio channel, a signal that is output from the processor 1510.

The memory 1520 may store at least one of information transmitted and received by the transceiver 1530 or information generated by the processor 1510. In addition, the memory 1520 may store control information or data included in an acquired signal. The memory 1520 may include a storage medium such as read-only memory (ROM), random access memory (RAM), a hard disk, compact disc ROM (CD-ROM), and a digital versatile disc (DVD), or a combination of storage media. Further, the memory 1520 may include a plurality of memories.

FIG. 16 is a block diagram of a base station 1600 according to an embodiment of the disclosure. As shown in FIG. 16, the base station 1600 of the disclosure may include a processor 1610, a transceiver 1630, and memory 1620. However, components of the base station 1600 are not limited to the examples set forth above. For example, the base station 1600 may include more components or less components than the components set forth above. In addition, the processor 1610, the transceiver 1630, and the memory 1620 may be implemented in the form of one chip.

According to the above-described communication method of the base station 1600, the transceiver 1630 and the processor 1610 may be operated.

The transceiver 1630 may transmit a signal to and receive a signal from a UE. Here, the signal may include control information and data. For this purpose, the transceiver 1630 may include an RF transmitter up-converting and amplifying a frequency of a transmitted signal, an RF receiver performing low-noise amplification and frequency down-conversion on a received signal, and the like. However, this is merely an example of the transceiver 1630, and components of the transceiver 1630 are not limited to the RF transmitter and the RF receiver.

In addition, the transceiver 1630 may receive a signal through a radio channel and output the signal to the processor 1610, and may transmit, through the radio channel, a signal that is output from the processor 1610.

The processor 1610 may store a program and data required for operations of the base station 1600. In addition, the processor 1610 may store control information or data included in a signal acquired by the base station 1600. The processor 1610 may include memory including a storage medium, such as ROM, RAM, a hard disk, CD-ROM, and a DVD, or a combination of storage media.

The processor 1610 may control a series of processes to allow the base station 1600 to be operated according to the above-described embodiment of the disclosure. For example, the processor 1610 may control to receive uplink control information transmitted by a terminal. The processor 1610 may control the transceiver 1630 to transmit information related to whether a hybrid automatic repeat request HARQ feedback function is disabled or not. The processor 1610 may control the transceiver 1630 to transmit downlink control information and a shared channel scheduled by the downlink control information.

The memory 1620 may store at least one of information transmitted and received by the transceiver 1630 or information generated by the processor 1610. In addition, the memory 1620 may store control information or data included in an acquired signal. The memory 1620 may include a storage medium such as ROM, RAM, a hard disk, CD-ROM, and a DVD, or a combination of storage media. Further, the memory 1620 may include a plurality of memories.

At least one embodiment of the present disclosure also provides a non-transitory computer-readable recording medium having stored thereon a program, which when performed by a computer, performs the methods described above.

According to an aspect of the present disclosure, there is provided a method performed by a user terminal UE, the method comprises: receiving information related to whether a hybrid automatic repeat request HARQ feedback function is disabled or not; based on the information, receiving downlink control information and a shared channel scheduled by the downlink control information.

According to the method performed by the user terminal UE provided by the present disclosure, wherein when the information indicates that the HARQ feedback function is disabled, the receiving the downlink control information includes: receiving downlink control information DCI for scheduling a physical downlink shared channel PDSCH or a physical uplink shared channel PUSCH; receiving DCI for scheduling blind retransmissions of the PDSCH or the PUSCH at least once at the soonest during a time interval since receiving the DCI for scheduling the PDSCH or PUSCH and less than a round trip time RTT.

The method performed by the user terminal UE according to the present disclosure further comprises: receiving system information, wherein the system information is used for indicating blind retransmission configuration or for indicating blind retransmission configuration of each hybrid automatic repeat request HARQ process, respectively; or receiving UE-specific radio resource control RRC signaling, wherein the UE-specific RRC signaling is used for indicating the blind retransmission configuration of the UE, or respectively indicating the blind retransmission configuration of each hybrid automatic repeat request HARQ process of the UE.

According to the method performed by the user terminal UE provided by the present disclosure, wherein only the HARQ process with the HARQ feedback function disabled is configured to be able to perform blind retransmission, or is able to perform blind retransmission by default.

According to the method performed by the user terminal UE provided by the present disclosure, wherein the DCI for scheduling the PDSCH or PUSCH contains a field for indicating whether there are blind retransmissions after the scheduled PDSCH or PUSCH; the method further comprises: if the DCI for scheduling the PDSCH or PUSCH indicates that there is no blind retransmission after the scheduled PDSCH or PUSCH, flushing buffered data corresponding to the PDSCH or PUSCH no matter whether the PDSCH or PUSCH is successfully decoded or not; if the DCI for scheduling the PDSCH or PUSCH indicates that there are blind retransmissions after the scheduled PDSCH or PUSCH, and the PDSCH or PUSCH is not successfully decoded, keeping the buffered data corresponding to the PDSCH or PUSCH; wherein the scheduled PDSCH or PUSCH includes initial transmissions or blind retransmissions of the scheduled PDSCH or PUSCH.

According to the method performed by the user terminal UE provided by the present disclosure, wherein the DCI for scheduling the PDSCH or PUSCH includes a number of blind retransmissions after the scheduled PDSCH or PUSCH; the method further comprises: if the DCI for scheduling the PDSCH indicates that the number of blind retransmissions after the scheduled PDSCH is 0, flushing buffered data corresponding to the PDSCH no matter whether the PDSCH is successfully decoded or not; and if the DCI for scheduling the PUSCH indicates that the number of blind retransmissions after the scheduled PUSCH is 0, flushing the buffered data corresponding to the PUSCH after transmitting the PUSCH.

According to the method performed by the user terminal UE provided by the present disclosure, a number or maximum number of the blind retransmissions of the PDSCH is a predefined value, or a value configured by radio resource control RRC signaling or media access control control element MAC CE.

The method performed by the user terminal UE according to the present disclosure, further comprises: transmitting hybrid automatic repeat request HARQ feedback to a base station when the number of the received blind retransmissions of the PDSCH reaches a maximum number of retransmissions.

The method performed by the user terminal UE according to the present disclosure, wherein the number or the maximum number of the blind retransmissions is configured respectively for each automatic repeat request HARQ process.

The method performed by the user terminal UE according to the present disclosure, further comprises: when the number of the received blind retransmissions of the PDSCH reaches a maximum number of blind retransmissions, flushing buffered data corresponding to the PDSCH no matter whether the PDSCH is successfully decoded or not; or when the number of the received blind retransmissions of the PUSCH reaches the maximum number of blind retransmissions, flushing the buffered data corresponding to the PUSCH after the last blind retransmission of the PUSCH is transmitted.

The method performed by the user terminal UE according to the present disclosure, further comprises: receiving at least one of the following indication information: information indicating a time interval, a first minimum time interval or a first maximum time interval between the DCI for scheduling the PDSCH or PUSCH and the DCI for scheduling the blind retransmissions of the PDSCH or PUSCH; information indicating a time interval, a second minimum time interval or a second maximum time interval between the PDSCH or PUSCH and the DCI for scheduling the blind retransmissions of the PDSCH or PUSCH; information indicating a time interval, a third minimum time interval or a third maximum time interval between the PDSCH or PUSCH and the blind retransmissions of the PDSCH or PUSCH; information indicating a time window for monitoring the blind retransmissions of the PDSCH or PUSCH, wherein a starting position of the time window is a position with a predefined or preconfigured interval after the DCI for scheduling the PDSCH or PUSCH, or a position with a predefined or preconfigured interval after the PDSCH or PUSCH; wherein at least one of the indication information is indicated by the DCI for scheduling the PDSCH or PUSCH, radio resource control RRC signaling or media access control control element MAC CE.

The method performed by the user terminal UE according to the present disclosure, further comprises: if the UE does not receive the DCI for scheduling blind retransmissions of the PDSCH or PUSCH within the first maximum time interval since receiving the DCI for scheduling the PDSCH or PUSCH; or, if DCI for scheduling blind retransmissions of the PDSCH is not received within the second maximum time interval from the PDSCH; or, if the blind retransmissions of the PDSCH is not received within the third maximum time interval from the PDSCH; or, if the blind retransmissions of the PDSCH are not monitored within the time window for monitoring the blind retransmissions of the PDSCH; flushing the buffered data corresponding to PDSCH or PUSCH.

According to the method performed by the user terminal UE provided by the present disclosure, wherein when the information indicates that the HARQ feedback function is disabled or on, the receiving the downlink control information comprises: receiving downlink control information DCI for scheduling a physical downlink shared channel PDSCH or a physical uplink shared channel PUSCH, wherein the DCI for scheduling the PDSCH or PUSCH contains a field for indicating a number of slots for the scheduled PDSCH or PUSCH slot aggregation transmission, wherein a size of the field for indicating the number of the slots for the scheduled PDSCH or PUSCH slot aggregation transmission in the DCI for scheduling the PDSCH or PUSCH is determined by a maximum number of the slots for the scheduled PDSCH or PUSCH slot aggregation transmission, which is configured via radio resource control RRC signaling or media access control control element MAC CE.

According to the method performed by the user terminal UE provided by the present disclosure, wherein the maximum number of slots is respectively configured for at least one of each quality of service QoS of the PDSCH or PUSCH, each hybrid automatic repeat request HARQ process of the PDSCH or PUSCH, each logical channel of the PDSCH or PUSCH, each priority of the PDSCH or PUSCH, each scheduling method of the PDSCH or PUSCH, and whether a HARQ feedback function of the PDSCH or PUSCH is enabled, wherein the scheduling method includes dynamic scheduling and semi-persistent scheduling.

According to the method performed by the user terminal UE provided by the present disclosure, wherein a plurality of time slots for the scheduled PDSCH or PUSCH time slot aggregation transmission are discontinuous.

According to the method performed by the user terminal UE provided by the present disclosure, wherein there is a same interval between each slot or each slot bundle among the plurality of slots for the scheduled PDSCH or PUSCH slot aggregation transmission, and the slot bundle refers to two or more consecutive slots.

The method performed by the user terminal UE according to the present disclosure, further comprises: receiving at least one of the following indication information: information indicating whether there is an interval between each slot or between each slot bundle among the plurality of slots for the scheduled PDSCH or PUSCH slot aggregation transmission; information indicating a size of an interval between each slot or between each slot bundle among the plurality of slots for scheduled PDSCH or PUSCH slot aggregation transmission; wherein at least one of the indication information is configured by DCI for scheduling PDSCH or PUSCH, radio resource control RRC signaling or media access control control element MAC CE. According to the method performed by the user terminal UE provided by the present disclosure, wherein there is the same interval between each slot or between each slot bundle among the plurality of slots for PDSCH slot aggregation transmission, and the slot bundle refers to two or more consecutive slots.

According to the method performed by the user terminal UE provided by the present disclosure, wherein the size of the slot bundle is configured by DCI for scheduling the PDSCH or PUSCH, radio resource control RRC signaling or media access control control element MAC CE.

The method performed by the user terminal UE according to the present disclosure, further comprises: when the slot for the scheduled PDSCH or PUSCH slot aggregation transmission is identified as an unavailable slot, the UE discards the signal that should be mapped to the slot or maps it to the next available slot.

According to the method performed by the user terminal UE provided by the present disclosure, wherein the information related to whether the hybrid automatic repeat request HARQ feedback function is disabled is related to a HARQ process number HPN, the method further comprises: determining whether the HARQ feedback function of a corresponding HARQ process is disabled based on the HARQ process number HPN, wherein PDSCH transmission with the HARQ feedback function enabled and PDSCH transmission with the HARQ feedback function disabled use different HARQ processes.

According to the method performed by the user terminal UE provided by the present disclosure, wherein a maximum number of HARQ processes with the HARQ feedback function disabled is N-1, and N is a total number of HARQ processes.

According to the method performed by the user terminal UE provided by the present disclosure, wherein the HARQ process with an indicated value of the HPN being 0 or N-1 enables the HARQ feedback function by default.

According to the method performed by the user terminal UE provided by the present disclosure, wherein the PDSCH transmission with the HARQ feedback function disabled only occupies one downlink DL HARQ process.

According to the method performed by the user terminal UE provided by the present disclosure, wherein when a HARQ process with downlink DL HARQ feedback function disabled or on is used for semi-persistent scheduling SPS PDSCH transmission, whether to perform HARQ feedback is determined according to the enable/disable configuration of the corresponding HARQ feedback function of the SPS PDSCH.

According to the method performed by the user terminal UE provided by the present disclosure, wherein the HARQ process number HPN includes explicit information and implicit information, wherein the explicit information is indicated by a field for indicating HPN contained in the received DCI, and the implicit information is indicated by at least one of the following ways: implicitly indicating by monitoring PDCCH using different cell radio network temporary identification C-RNTI values; implicitly indicating by monitoring physical downlink control channel PDCCH in different PDCCH search spaces; implicitly indicating by monitoring PDCCH in different slots; implicitly indicating by monitoring PDCCH in different frequency domain resources.

The method performed by the user terminal UE according to the present disclosure, further comprises, wherein the information related to whether the hybrid automatic repeat request HARQ feedback function is disabled includes at least one of: information indicating a number of downlink DL HARQ processes with the hybrid automatic repeat request HARQ feedback function disabled; information indicating a number of DL HARQ processes with the HARQ feedback function enabled; information indicating a total number of DL HARQ processes; wherein at least one of the information is configured by radio resource control RRC signaling or media access control control element MAC CE.

According to the method performed by the user terminal UE provided by the present disclosure, wherein DL HARQ processes with the HARQ feedback function enabled use continuous HARQ process numbers, which increase from the smallest HARQ process number or decrease from the largest HARQ process number.

According to the method performed by the user terminal UE provided by the present disclosure, wherein the information related to whether the hybrid automatic repeat request HARQ feedback function is disabled includes: information respectively indicating whether each downlink DL HARQ process supports HARQ feedback, wherein the information is configured by radio resource control RRC signaling or media access control control element MAC CE.

According to the method performed by the user terminal UE provided by the present disclosure, wherein the receiving information related to whether a hybrid automatic repeat request HARQ feedback function is disabled comprises: receiving radio resource control RRC signaling or media access control control element MAC CE for configuring information of a downlink DL HARQ process with the HARQ feedback function disabled; in the DL HARQ process, receiving downlink control information DCI containing information for indicating whether HARQ feedback needs to be performed for current PDSCH transmission.

According to the method performed by the user terminal UE provided by the present disclosure, wherein the information related to whether the hybrid automatic repeat request HARQ feedback function is disabled includes DCI for scheduling PDSCH with HARQ feedback function enabled and DCI for scheduling PDSCH with HARQ feedback function disabled, and both have the same DCI format. The method further comprises: determining whether the corresponding PDSCH needs to perform HARQ feedback by at least one of the following ways: determining whether the corresponding PDSCH needs to perform HARQ feedback by monitoring physical downlink control channel PDCCH by using different cell radio network temporary identification C-RNTI values; or determining whether the corresponding PDSCH needs to perform HARQ feedback by monitoring PDCCH in different PDCCH search spaces; or determining whether the corresponding PDSCH needs to perform HARQ feedback by monitoring PDCCH in different slots; or determining whether the corresponding PDSCH needs to perform HARQ feedback by monitoring PDCCH in different frequency domain resources; or determining whether the corresponding PDSCH needs to perform HARQ feedback through the HARQ process number HPN; or determining whether the corresponding PDSCH needs to perform HARQ feedback through a specific field included in DCI for scheduling PDSCH.

According to the method performed by the user terminal UE provided by the present disclosure, wherein the information related to whether the hybrid automatic repeat request HARQ feedback function is disabled includes DCI for scheduling PDSCH with HARQ feedback function enabled and DCI for scheduling PDSCH with HARQ feedback function disabled, and both have different DCI formats, and the method further comprises: the UE determines whether the corresponding PDSCH needs to perform HARQ feedback according to the monitored DCI format.

According to an aspect of the present disclosure, there is provided a method for indicating HARQ process number HPN, wherein the HPN includes explicit information and implicit information, wherein the explicit information is indicated by a field for indicating HPN contained in downlink control information DCI, and the implicit information is indicated by at least one of the following ways: implicitly indicating by monitoring PDCCH using different cell radio network temporary identification C-RNTI values; implicitly indicating by monitoring physical downlink control channel PDCCH in different PDCCH search spaces; implicitly indicating by monitoring PDCCH in different slots; implicitly indicating by monitoring PDCCH in different frequency domain resources.

According to an aspect of the present disclosure, there is provided a method performed by a base station, the method comprises: transmitting information related to whether a hybrid automatic repeat request HARQ feedback function is disabled or not; transmitting downlink control information and a shared channel scheduled by the downlink control information.

According to another aspect of the present disclosure, there is provided a terminal, the terminal comprising: a transceiver configured to transmit and receive signals with the outside; and a processor configured to control the transceiver to perform a method according to any one of the above methods performed by the user terminal.

According to another aspect of the present disclosure, there is provided a base station comprising a transceiver configured to transmit and receive signals with the outside; and a processor configured to control the transceiver to perform a method according to any one of the methods performed by the above base station.

According to another aspect of the present disclosure, there is provided a non-transitory computer-readable recording medium having stored thereon a program, which when performed by a computer, performs any one of the methods described above.

1-15. (canceled)

16. A method performed by a user equipment (UE), the method comprising:
receiving information related to whether a hybrid automatic repeat request (HARQ) feedback for a HARQ process is disabled;
receiving a physical downlink shared channel (PDSCH) for the HARQ process; and
in case that the information indicates that the HARQ feedback for the HARQ process is disabled, receiving DCI or another PDSCH for the HARQ process after a time interval from the reception of the PDSCH.

17. The method of claim 16, wherein the time interval is related to a processing time of the PDSCH.

18. The method of claim 16, wherein the information related to whether the HARQ feedback for the HARQ process is disabled is received through system information or radio resource control (RRC) signaling.

19. The method of claim 16, wherein the PDSCH includes a slot aggregated PDSCH.

20. A user equipment (UE), comprising:
a transceiver configured to receive signals; and
a processor configured to control the transceiver to:
receive information related to whether a hybrid automatic repeat request (HARQ) feedback for a HARQ process is disabled,
receive a physical downlink shared channel (PDSCH) for the HARQ process, and
in case that the information indicates that the HARQ feedback for the HARQ process is disabled, receive DCI or another PDSCH for the HARQ process after a time interval from the reception of the PDSCH.

21. The UE of claim 20, wherein the time interval is related to a processing time of the PDSCH.

22. The UE of claim 20, wherein the information related to whether the HARQ feedback for the HARQ process is disabled is received through system information or radio resource control (RRC) signaling.

23. The UE of claim 20, wherein the PDSCH includes a slot aggregated PDSCH.

24. A method performed by a base station, the method comprising:
transmitting information related to whether a hybrid automatic repeat request (HARQ) feedback for a HARQ process is disabled;
transmitting a physical downlink shared channel (PDSCH) for the HARQ process; and
in case that the information indicates that the HARQ feedback for the HARQ process is disabled, transmitting DCI or another PDSCH for the HARQ process after a time interval from the transmission of the PDSCH.

25. The method of claim 24, wherein the time interval is related to a processing time of the PDSCH.

26. The method of claim 24, wherein the information related to whether the HARQ feedback for the HARQ process is disabled is transmitted through system information or radio resource control (RRC) signaling.

27. The method of claim 24, wherein the PDSCH includes a slot aggregated PDSCH.

28. A base station, comprising:
a transceiver; and
a processor configured to control the transceiver to:
transmit information related to whether a hybrid automatic repeat request (HARQ) feedback for a HARQ process is disabled,
transmit a physical downlink shared channel (PDSCH) for the HARQ process, and
in case that the information indicates that the HARQ feedback for the HARQ process is disabled, transmit DCI or another PDSCH for the HARQ process after a time interval from the transmission of the PDSCH.

29. The base station of claim 28, wherein the time interval is related to a processing time of the PDSCH.

30. The base station of claim 28, wherein the information related to whether the HARQ feedback for the HARQ process is disabled is transmitted through system information or radio resource control (RRC) signaling.

31. The base station of claim 28, wherein the PDSCH includes a slot aggregated PDSCH.
